(19) United States
(12) Patent Application Publication
(10) Pub. No.: US 2010/0268464 A1
(43) Pub. Date: Oct. 21, 2010

(54) NAVIGATION METHOD FOR A COMMUNICATION DEVICE

(75) Inventor: SHENG-HUNG YANG, Taoyuan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXCONN COMMUNICATION TECHNOLOGY CORP., Taoyuan County (TW)

(21) Appl. No.: 12/648,039

(22) Filed: Dec. 28, 2009

(30) Foreign Application Priority Data
Apr. 21, 2009 (CN) 200910301730.4

(51) Int. Cl. G01C 21/00

(52) U.S. Cl. 701/213; 701/207

(57) ABSTRACT

A navigation method for a communication device sends a navigational route request from the communication device to the server to generate a navigation contact group, sends a join message to join the navigation contact group as a group member, the navigational route request includes a start time and a time interval, and receives position information of the group members at each time interval from the server. The method further selects a position of a target group member from the position information of the group members, receives updated position information of the target group member from the server, and provides navigational route for the communication device according to the updated position information of the target group member using a global position system of the communication device.

BACKGROUND

1. Technical Field

Embodiments of the present disclosure relate to positioning methods, and more particularly to a navigation method for a communication device.

2. Description of Related Art

A global positioning system (GPS) of an electronic device may provide position information of the electronic device and a moving direction of an object to a target position. However, if the target position updates frequently, a user of the electronic device has to input the updated target position into the electronic device so as to acquire an updated moving direction from the GPS. Thus, it is inconvenient for user to acquire a navigational route of a moving target.

### BRIEF DESCRIPTION OF THE DRAWINGS

FIG. 1 is a block diagram of one embodiment of a communication device including a positioning system.

FIG. 2 is a flowchart of one embodiment of a method for requesting a navigational route from a communication device to a server.

FIG. 3 is a flowchart of one embodiment of a method for providing a navigational route from the server to the communication device.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

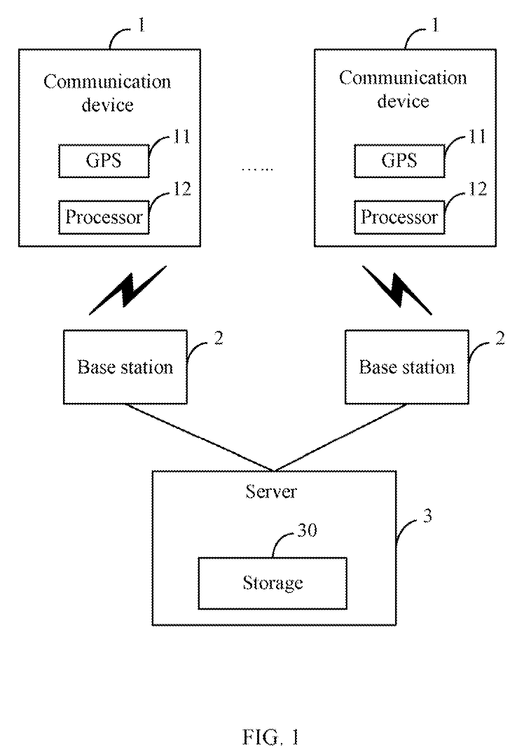

FIG. 1 is a block diagram of one embodiment of a communication device 1 in communication with a server 3. The communication device 1 is used to set a navigation contact group in the server 3, receive updated position information of the group members in the navigation contact group according to a determined time interval from the server 3, and provide a navigational route according to the updated position information of a target group member. The navigation contact group is operable to store one or more communication devices 1 as group members according to phone numbers of the one or more communication devices 1.

The communication device 1 may be a mobile phone, a personal digital assistant (PDA), a handheld computer, or any other kind of computing device. In one embodiment, as shown in FIG. 1, the communication device 1 may include a global positioning system (GPS) 11, and a processor 12. The GPS 11 is operable to locate a position of the communication device 1. The processor 12 executes one or more computerized operations of the communication device 1 and other applications, to provide functions of the communication device 1.

The communication device 1 communicates with the server 3 via a plurality of basic stations 2. The server 3 may be used to establish a navigation contact group according to a navigational route request from the communication device 1, receive position information of the communication device 1 and save the position information in a storage 30 of the server 3. In one embodiment, the server 3 may be constructed by China Unicorn, China Mobile, China Telecom server, or any other business company.

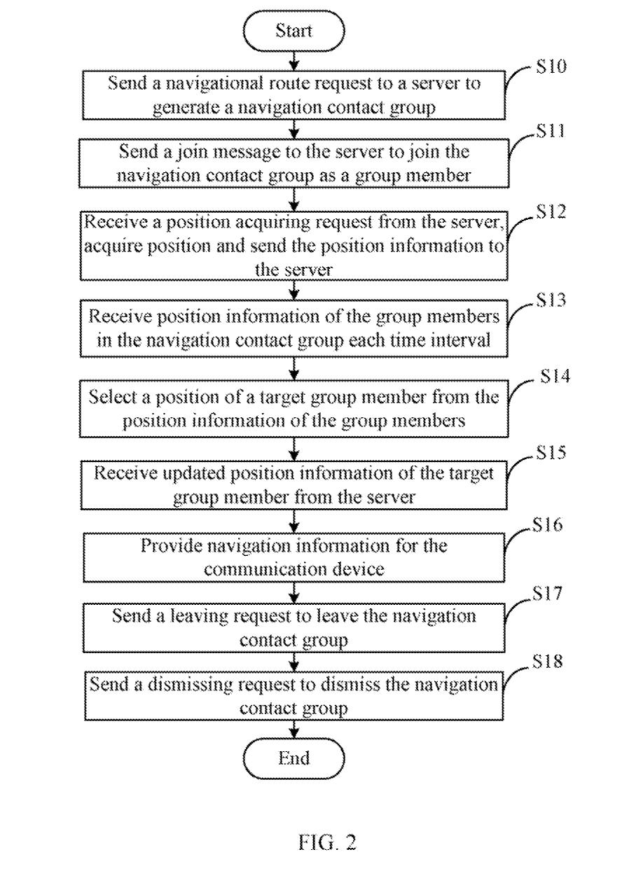

FIG. 2 is a flowchart of one embodiment of a method for requesting a navigational route from the communication device 1 to the server 3. Depending on the embodiment, additional blocks may be added, others removed, and the ordering of the blocks may be replaced.

In block S10, the communication device 1 sends the navigational route request to the server 3 to generate a navigation contact group. The navigational route request may include, but are not limited to, a name of the navigation contact group (e.g., convocation), a timestamp of the navigation contact group, and a time interval (e.g., every two minutes) for updating position information of group members in the navigation contact group. For example, the timestamp may include a start time (e.g., ten-thirty on Jan. 1, 2009), and an end time (e.g., ten-thirty on Jan. 2, 2009).

In block S11, the communication device 1 sends a join message to the server 3 to join the navigation contact group as a group member. The join message may include a name of the navigation contact group that needs to join, a phone number of a communication device 1. One or more other communication devices may join the navigation contact group as group members by sending the join message to the server 3.

In one embodiment, the server 3 needs to collect position information of all group members of the navigation contact group. In block S12, the communication device 1 receives a position acquiring request from the server 3, acquires position of the communication device 1 by the GPS 11, and sends the position information to the server 3.

The server 3 may send the collected position information to each of the group members at each time interval if the start time is reached. In block S13, the communication device 1 receives the position information of the group members in the navigation contact group at each time interval from the server 3. In one embodiment, each of the position information may include GPS coordinates of each group member, a name of the navigation contact group, a phone number of each group member, for example.

In block S14, a user of the communication device 1 selects a position of a target group member from the position information of the group members. For example, if the user of the communication device 1 wants to meet a target group member with the phone number “123456,” the user may select position information of the phone number “123456.” The GPS 11 may provide navigational route for the user according to the position information of the phone number “123456.”

The server 3 receives the selected position of the target group member from the communication device 1, sends the updated position information of the target group member in the navigation contact group to each of the group members. In block S15, the communication device 1 receives updated position information of the target group member from the server 3.

In block S16, the communication device 1 provides navigational route according to the updated position information of the target group member using a GPS 11 of the communication device 1.

In block S17, the communication device 1 sends a leaving request to leave the navigation contact group.

In block S18, the communication device 1 sends a dismissing request to dismiss the navigation contact group. In one embodiment, only the communication device 1 that set the navigation contact group has an authority to dismiss the navigation contact group.

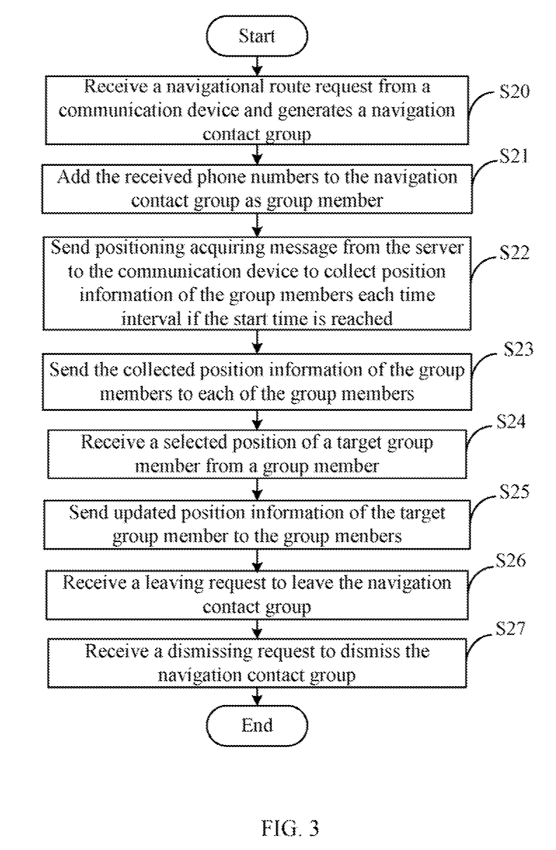

FIG. 3 is a flowchart of one embodiment of a method for providing a navigational route from the server 3 to the communication device 1. Depending on the embodiment, additional blocks may be added, others removed, and the ordering of the blocks may be replaced. Amend correspondingly

In block S20, the server 3 receives the navigational route request from the communication device 1 and generates a navigation contact group. The server 3 receives the navigational route request, sets the navigation contact group, set the start time and an end time according to the timestamp of the navigation contact group, set the time interval for updating position of group members in the navigation contact group according to the time interval, and saves the navigation contact group in the storage 30.

In block S21, the server 3 receives join messages from one or more communication devices 1 and adds the one or more communication devices 1 into the navigation contact group as group members according to phone numbers of the one or more communication devices 1. The join message may include a name of the navigation contact group that needs to join, a phone number of a communication device 1. The server 3 receives the join messages, search for the navigation contact group according to the name of the navigation contact group in the each of the join messages, and saves the phone numbers of the communication device 1 to the searched navigation contact group as a group member.

In block S22, if the start time of the navigation contact group reached, the server 3 send positioning acquiring message to the group members to collect position information of the group members at each time interval.

In block S23, the server 3 send the collected position information of the group members in the navigation contact group to each of the group members.

In block S24, the server 3 receive a selected position of a target group member from a group member.

In block S25, if the position of the target group member updates to a updated position, the server 3 send the updated position information of the target group member in the navigation contact group to each of the group members. The communication device 1 provides navigational route according to updated position information of the target group member using the GPS 11 of the communication device 1.

In block S26, the server 3 receives a leaving request to leave the navigation contact group from the communication device 1. The leaving request may include a name of the navigation contact group need to leave, a phone number of the communication device 1. The server 3 searches the storage 30 for the navigation contact group according to the name of the navigation contact group need to leave, and deletes the phone number of the communication device 1 in the searched navigation contact group.

In block S27, the server 3 receives a dismissing request to dismiss the navigation contact group from the communication device 1. The dismissing request may include a name of the navigation contact group need to close, a phone number of the communication device 1. The server 3 searches the storage 30 for the navigation contact group according to the name of the navigation contact group need to dismiss, and dismisses the searched navigation contact group in the storage 30.

Although certain inventive embodiments of the present disclosure have been specifically described, the present disclosure is not to be construed as being limited thereto. Various updates or modifications may be made to the present disclosure without departing from the scope and spirit of the present disclosure.

What is claimed is:

1. A method for requesting a navigational route from a communication device to a server, the method comprising:
(a) sending the navigational route request from the communication device to the server to generate a navigation contact group, and sending a join message to join the navigation contact group as a group member, the navigational route request comprising a start time and a time interval;
(b) receiving position information of the group members at each time interval from the server if the start time is reached;
(c) selecting a position of a target group member from the position information of the group members;
(d) receiving updated position information of the target group member from the server; and
(e) providing navigational route for the communication device according to the updated position information of the target group member using a global position system of the communication device.

2. The method according to claim 1, wherein the navigational route request comprises a name of the navigation contact group.

3. The method according to claim 1, further comprising:
(f) sending a leaving request to the server to leave the navigation contact group; and/or
(g) sending a dismissing request to the server to dismiss the navigation contact group.

4. A method for providing a navigational route from a server to a communication device, the method comprising:
(a) receiving the navigational route request from a communication device to generate a navigation contact group, the navigational route request comprising a start time and a time interval;
(b) receiving join messages from one or more communication devices and adding the one or more communication devices into the navigation contact group as group members according to phone numbers of the one or more communication devices;
(c) sending positioning acquiring message from the server to the group members to collect position information of the group members at each time interval if the start time is reached;
(d) sending the collected position information of the group members to each of the group members;
(e) receiving a selected position of a target group member from a group member;
(f) sending updated position information of the target group member from the server to the group member.

5. The method according to claim 4, wherein a global position system in a communication device of each of the group members provides navigational route according to updated position information of the target group member.

6. The method according to claim 4, wherein the navigational route request further comprises a name of the navigation contact group.

7. The method according to claim 4, further comprising:
(g) receiving a leaving request from a group member to leave the navigation contact group; and
(h) deleting the group member from the navigation contact group.

8. The method according to claim 4, further comprising:
(i) receiving a dismissing request from a group member to dismiss the navigation contact group; and
(j) dismissing the navigation contact group.

9. A computer readable medium having stored thereon instructions that, when executed by a processor, causing the processor to perform positioning method for requesting a navigational route from a communication device to a server, the method comprising:
(a) sending the navigational route request from the communication device to the server to generate a navigation contact group, and sending a join message to join the navigation contact group as a group member, the navigational route request comprising a start time and a time interval;
(b) receiving position information of the group members at each time interval from the server;
(c) selecting a position of a target group member from the position information of the group members;
(d) receiving updated position information of the target group member from the server; and
(e) providing navigational route for the communication device according to the updated position information of the target group member using a global position system of the communication device.

10. The medium according to claim 9, wherein the navigational route request comprises a name of the navigation contact group.

11. The medium according to claim 9, further comprising:
(f) sending a leaving request to the server to leave the navigation contact group; and/or
(g) sending a dismissing request to the server to dismiss the navigation contact group.
